(19) United States
(12) Patent Application Publication
(10) Pub. No.: US 2006/0074694 A1
(43) Pub. Date: Apr. 6, 2006

(54) Method for extracting periodic signal components, and apparatus for this purpose

(76) Inventor: Volker Hohmann, Oldenburg (DE)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/223,125

(22) Filed: Sep. 12, 2005

(30) Foreign Application Priority Data
Sep. 17, 2004 (DE) 10 2004 045 0978.

(51) Int. Cl. G10L 21/04

(52) U.S. Cl. 704/503

(57) ABSTRACT

A method for extracting periodic signal components from at least one superimposed signal has the following steps:
the superimposed signal is split into subsegments of the same period lengths (T₁, T₂, . . . , Tₙ) for a respective set of predefined period lengths (T₁, T₂, . . . , Tₙ), and
for each period length (T₁, T₂, . . . , Tₙ) a superimposition of the signal values of the respective subsegments is formed.

The invention relates to a method for extracting periodic signal components from at least one superimposed signal, and also to an apparatus for this purpose.

For automatic speech recognition or for speech processing in hearing aids to suppress noise and to improve the signal, for example, it is useful to extract periodic signal components from a superimposed signal. This is because periodic signal components carry important information in a large number of natural and artificial signals. In speech signals, the vocal and voiced consonants are quasi-periodic signal components. Perception of them is crucial for speech intelligibility. In musical signals, the note played by a specific musical instrument is defined by the period length of the periodic signal produced by the instrument, whereas the timbre is defined by a period of the signal in the time domain.

Conventional methods for extracting periodic signal components from superimposed signals in the time domain operate largely on the basis of autocorrelation functions. By contrast, methods in the frequency domain use comb filters to extract a plurality of fundamentals from the frequency spectrum.

Since speech and music are nonstationary signals with varying superimposed components, the analysis needs to be performed in time segments using an analysis window length which matches the respective problem and the period length to be extracted.

R. J. McAulay and T. F. Quatieri, “Sinusoidal coding”, in: Speech Coding and Synthesis (W. B. Kleijn and K. K. Paliwal, publishers), Elsevier, 1998, section 4, page 135, describes a method for adaptive selection of the resolution for this.

US 2003-0088401 describes a method in which a fixed window length is avoided by using phase space reconstruction methods known from the analysis of multidimensional chaotic signals. Each window of samples is transformed using a sequence of n-dimensional vectors which describe a trajectory in the n-dimensional state space. The adjacent pairs of vectors are then selected and accumulated in order to determine a periodicity histogram.

Roy Patterson et al.: “Time-domain modeling of peripheral auditory processing: A modular architecture and a software platform”, in J. Acoustic Society Am. 98(4), October 1995, pages 1890 to 1894, describes a method for functional simulation of an auditory spectral analysis.

Xiaoshu Qian and Ramdas Kumaresan: “Joint estimation of Time Delay and Pitch of Voiced Speech Signals”, in: Conference Record of the Twenty-Ninth Asilomar Conference on Signals, Systems and Computers. IEEE. 1996, (1), pages 735 to 739, describes a method for determining the time delay for an audio signal.

DD 264 357 A3 describes a method for determining time profiles for the periods in signals. In this case, a vector distance is ascertained from measured values for a time period of a signal and a time-shifted signal portion for different displacements.

DE 692 31 266 T2 discloses a method for manipulating audio-equivalent signals in which the duration of an output signal is manipulated by repeating, maintaining and/or suppressing segment signals. The segment signals are formed by weighting window functions for reciprocally overlapping time windows in the original signal.

The overlapping time windows extracted from a superimposed signal have segments of different length which are superimposed on one another.

In this prior art, the signal to be analyzed has just one period length at a time and has no superimposed noise.

It is an object of the invention to provide an improved method for extracting periodic signal components from at least one superimposed signal which is particularly simple and stable and allows a further analysis of the periodic signal component in the time or frequency domain.

The invention achieves the object for the method of the generic type by virtue of the superimposed signal being split into respective chronologically successive subsegments of the same length, where the length corresponds to a particular period length of the periodic signal component which is to be extracted, for a respective set of predefined period lengths, and for each subsegment of the same period length the superimposition of the signal values of the respective subsegments of the same length being formed separately for all the period lengths.

It is thus possible to determine the number of periodic components, their corresponding signal peaks, the fundamentals and the time response of a superimposed signal which is to be observed.

To this end, a set of possible period lengths is defined and subsequently averaged in period sync. This means that it is possible, in principle, to improve the signal-to-noise ratio SNR of a periodic signal component for a respective hypothetical period length by 3 dB by doubling the number of superimpositions of subsegments. Averaging 8 subsegments, for example, results in an SNR improvement of approximately 9 dB. This means significant isolation of each periodic component from periodic components with other period lengths and noise signal components.

The superimposition of the signal values of all the subsegments for each period length is preferably formed by calculating the mean or median of the signal values of all the subsegments. Optionally, the superimposition of the signal values of the subsegments may also be formed by low-pass filtering the signal values of all the subsegments separately for each respective position within the subsegment.

The set of period lengths may have an unchanged permanent definition or may be adaptively selected.

It is particularly advantageous if the extraction is made on a superimposed wideband signal. It is also possible to perform parallel extraction of the periodic signal components from signals at outputs of a plurality of bandpass filters for the superimposed signal. Optionally, the periodic signal components may be extracted from a full superimposed signal or from sequences of segments of the superimposed signal.

The signal processing may thus take place successively for a sequence of segments of the signal or in parallel, for example for the signal at the outputs of a large number of bandpass filters and/or a large number of receivers.

The superimposition of the signal values of the respective subsegments may be formed in the time domain or in the frequency domain. In this case, it is advantageous if a frequency analysis of the formed superimposition of the subsegments is performed using fast Fourier transformation, wavelet transformation or linear prediction (LPC), for example.

It is also possible to reconstruct a signal in the time domain from a subset of the superimpositions formed.

Of fundamental importance to understanding the further processing of signals is that the superimpositions formed form the basic functions, i.e. the time profile of the signal components at the respective period lengths.

The superimpositions formed may be compared for various signal channels of a multichannel system. It is also possible to compare the superimpositions formed for the various frequency bands of a multifrequency band system. This is dependent on the respective signal post-processing strategy. By way of example, automatic speech recognition using the superimpositions formed can be performed by utilizing the aforementioned post-processing methods.

It is also an object of the invention to provide an apparatus for extracting periodic signal components from a superimposed signal using such a method. The object is achieved with an apparatus which has a signal splitter for splitting the superimposed signal into subsegments, means connected to the output of the signal splitter for forming the superimposition of the signal values of the respective subsegments, and buffer stores for each period length for storing the superimposed signal values of the respective subsegments.

In this context, the size of the buffer stores is preferably chosen on the basis of the defined period length.

The invention is explained in more detail below by way of example with reference to the appended drawing, in which:

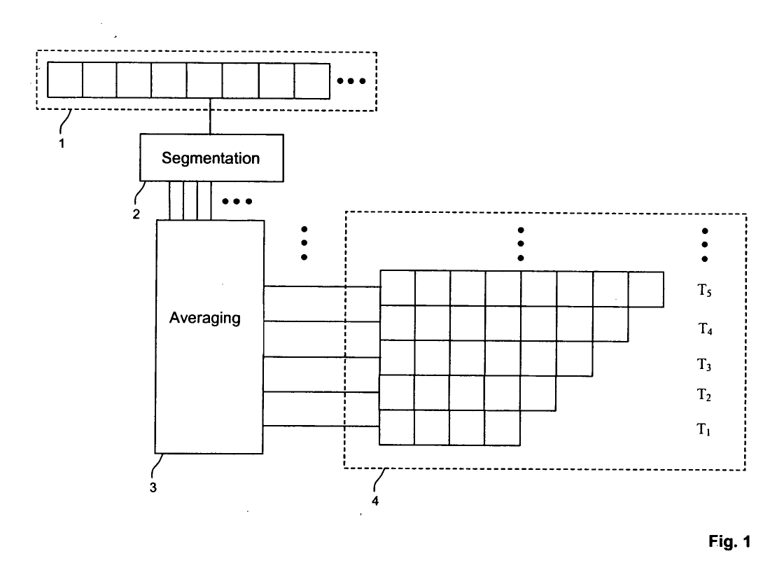

FIG. 1 shows a block diagram of the inventive apparatus for extracting periodic signal components from a superimposed signal.

FIG. 1 shows a block diagram of an apparatus for extracting periodic signal components from a superimposed digital signal 1. This signal is segmented into subsegments using a signal splitter 2. The subsegments provided at the output of the signal splitter 2 are supplied to means 3 for forming the superimposition of the signal values of the respective subsegments and are stored in buffer stores 4 for each period length T₁, T₂, . . . , Tₙ. The length Tᵢ of the buffer stores 4 is in this case respectively chosen such that it corresponds to the period length of the associated subsegments.

The superimposition of the signal values of the subsegments for each period length T₁, T₂, . . . , Tₙ can be calculated by calculating the mean or median of the signal values of all the subsegments, for example. Optionally, however, it is also possible for a low-pass filter to be provided for determining the average of the signal values for each subsegment. The superimposition is effected separately for each respective position within the subsegment.

The set of period lengths may have an unchanged permanent definition. Alternatively, adaptive selection of the period lengths T₁, T₂, . . . , Tₙ may be carried out. In this context, the lengths Tᵢ, where i=1 to n, of the respective buffer stores 4 are adaptively adjusted, which means that it is necessary to use an appropriate variable buffer store 4.

The signal values averaged in period sync which are stored in the buffer stores 4 are basic functions which describe the time response of the signal components at the respective period lengths and which can be processed further in the time domain or in the frequency domain, for example for automatic speech recognition or for signal processing for hearing aids.

1. A method for extracting periodic signal components from at least one signal (1) with superimposed signal components having different period lengths than those of the extracted periodic signal components and/or with superimposed noise signal components, characterized by
the superimposed signal (1) being split into respective chronologically successive subsegments of the same length (T), where the length corresponds to a particular period length of the periodic signal component which is to be extracted, for a respective set of predefined period lengths (T₁, T₂, . . . ), and
for each period length (T₁, T₂, . . . ) a superimposition of the signal values of the respective subsegments of the same length being formed.

2. The method as claimed in claim 1, wherein the superimposition of the signal values for each period length (T₁, T₂, . . . ) is formed by calculating the mean or median of the signal values of all the subsegments separately for each respective position within the subsegment.

3. The method as claimed in claim 1, wherein the superimposition of the signal values for each period length (T₁, T₂, . . . ) is formed by low-pass filtering the signal values of all the subsegments and separately for each respective position within the subsegment.

4. The method as claimed in claim 1, wherein the period lengths (T₁, T₂, . . . ) have an unchanged permanent definition.

5. The method as claimed in claim 1, characterized by adaptive selection of the period lengths (T₁, T₂, . . . ).

6. The method as claimed in claim 1, wherein the extraction is made from a superimposed wideband signal.

7. The method as claimed in claim 1, characterized by parallel extraction of the periodic signal components from signals at outputs of a plurality of bandpass filters for the superimposed signal (1).

8. The method as claimed in claim 1, characterized by extraction of the periodic signal components from a full superimposed signal (1) or from sequences of segments of the superimposed signal (1).

9. The method as claimed in claim 1, characterized by parallel extraction of the periodic signal components from a plurality of signal channels.

10. The method as claimed in claim 1, characterized by formation of the superimposition of the signal values of the respective subsegments in the time domain or in the frequency domain.

11. The method as claimed in claim 1, characterized by a more extensive signal analysis of the formed superimposition of the subsegments for all the period lengths (T₁, T₂, . . . ).

12. The method as claimed in claim 11, wherein the more extensive signal analysis is performed using fast Fourier transformation, wavelet transformation or linear prediction (LPC).

13. The method as claimed in claim 1, characterized by reconstruction of a signal in the time domain from a subset of the formed superimpositions of the subsegments.

14. The method as claimed in claim 1, characterized by comparison of the subsegments' superimpositions formed for various signal channels of a multichannel system.

15. The method as claimed in claim 1, characterized by comparison of the subsegments' superimpositions formed for various frequency bands of a multifrequency band system.

16. The method as claimed in claim 1, characterized by determination of the fundamental arising in the superimposed signal (1) and formation of said fundamental from the subsegment superimpositions or more extensive analyses of the subsegment superimpositions.

17. The method as claimed in claim 1, characterized by automatic speech recognition using the formed superimpositions of the subsegments.

18. An apparatus for extracting periodic signal components from a superimposed signal using the method as claimed in claim 1, characterized by
a signal splitter (2) for splitting the superimposed signal (1) into subsegments,
a means (3), connected to the output of the signal splitter (2), for forming the superimposition of the signal values of the respective subsegments, and
buffer stores (4) for each period length (T₁, T₂, . . . ) for storing the superimposed signal values of the respective subsegments.

19. The apparatus as claimed in claim 18, wherein the size of the buffer stores (4) is dependent on the defined period length of the associated subsegments.
